(19) United States
(12) Patent Application Publication
(10) Pub. No.: US 2005/0141482 A1
(43) Pub. Date: Jun. 30, 2005

(54) Control of a speech communication link in a packet-switched communication network between communication devices associated with different domains

(76) Inventor: Patrick Kleiner, (US)

Correspondence Address: Siemens Corporation;Intellectual Property Department, 170 Wood Avenue South, Iselin, NJ, 08830, US

(21) Appl. No.: 10/510,222

(22) PCT Filed: Apr. 1, 2003
(86) PCT No.: PCT/EP03/03399

(30) Foreign Application Priority Data
Apr. 3, 2002 (EP) 02007572.7

(51) Int. Cl. H04L 12/56; H04L 12/66

(52) U.S. Cl. 370/352; 370/401

(57) ABSTRACT

The invention essentially relates to the configuration of a network element and to a method for processing signalling data and controlling the connection of a speech communication link between at least two communication devices of subscribers in a communication network, whereby said communication devices are associated with different domains. The inventive network element comprises at least one signalling transmission unit for converting data formats from signalling data emerging from a first domain into a data format suitable for transmitting the signaling data to a second domain and at least one media-transmission unit for converting the data format of the useful data arising from the first domain and associated with the speech communication link into a data format suitable for transmitting the user data to the second domain. The signalling transmission unit also comprises communication means for controlling the media-transmission unit by using the information from the signalling data.

Network element and method for processing signaling data and controlling the connection of a voice communication link between at least two communication terminals associated with different packet-switched communication networks or domains.

The invention relates to a network element and a method for processing signaling data and controlling the connection of a voice communication link between at least two communication terminals within a packet-switched communication network associated with different packet-switched communication networks or domains.

In a communication link between subscribers in a packet-switched communication network (e.g. Voice Over IP) the payload data is typically not routed via a switching system. Only in known hybrid telecommunication networks, which represent a convergence of conventional time division multiplex communication networks or circuit-switched communication networks with packet-switched communication networks, is the payload data routed via a switching system, in so far as a subscriber in a conventional circuit-switched communication network is involved in a communication link and is therefore not directly accessible via the packet-switched communication network. In such a case it is necessary to convert the payload data so that it is suitable for use with the transmission technology used in the different communication networks. Such a conversion is particularly necessary for a transfer from a packet-switched communication network with packet transmission technology to a circuit-switched communication network with time division multiplex (TDM) transmission technology. Such a conversion is carried out both for the transmission of data from the communication network with time division multiplex transmission technology for a communication network with packet-transmission technology (e.g. IP or ATM) and for the transmission of data from the communication network with packet transmission technology for a communication network with time division multiplex transmission technology. In the case of a voice communication link between at least two subscribers in a packet-switched communication network, their payload data is preferably exchanged directly via the packet-switched communication network. In this instance the payload data is therefore not generally routed via the switching system using converters or gateways.

Telephony subscribers in a packet-switched communication network are for example subscribers who are connected to an internet protocol based network directly or via a dial-up connection. As well as access to the packet-switched communication network, the subscriber also has access to voice and/or fax services. These voice and/or fax services should have the same performance range as that offered by conventional telephones and faxes. In particular the voice payload data of such a subscriber is transmitted according to the internet protocol as data packets, e.g. according to what is known as the User Datagram Protocol (UDP). Signaling information is transmitted in the packet-switched communication network using signaling packets according to defined standards, e.g. H.323, H.225, H.245, H.450, SIP, SIP-T and BICC.

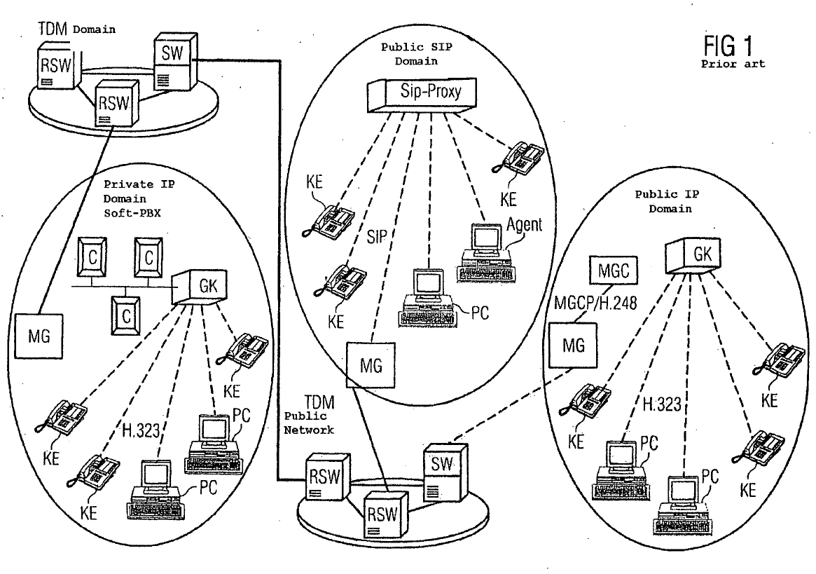

In packet-switched communication networks signaling data and payload data are generally transmitted on separate transmission paths. Payload data is routed directly to the further subscriber. If it is necessary to convert the payload data format from TDM to IP or ATM, the payload data is routed to an interface unit for conversion, e.g. a media gateway MG, as also shown in FIG. 1. Signaling data is routed by means of signaling data packets to a switching entity, e.g. a media gateway controller MGC (see FIG. 1), which controls the connection.

FIG. 1 shows an exemplary network constellation of a hybrid communication network according to the prior art. This is for example a private packet-switched communication network with an IP domain, having as its components a plurality of communication terminals (H.323) KE as well as computer systems, e.g. personal computers PC, a gatekeeper GK in an H.323 domain, which is in some instances connected to a plurality of servers C, or a SIP proxy server SIP proxy in a SIP domain and a media gateway MG with a connection to a private circuit-switched communication network with TDM technology (TDM=Time Division Multiplex) via a remote switching unit RSW. Such a private packet-switched and circuit-switched communication network can for example be a company communication network.

Such private circuit-switched communication networks, also referred to as private TDM communication networks, are connected to a public TDM communication network, which also has components such as remote switching units RSW and switching systems SW. This public TDM communication network can be connected to further packet-switched communication networks, both private and public, as shown in FIG. 1 with the designations public SIP domain or public IP domain. The packet-switched communication networks shown are generally divided into so-called zones or domains. FIG. 1 shows respectively that a private packet-switched communication network has one domain and each public packet-switched communication network has its own domain.

Currently existing packet-switched communication networks or domains, which provide voice communication services, are generally systems that are isolated from each other. Within a packet-switched communication network inside the boundaries of the specific domains voice communication links are possible between two or a plurality of subscriber communication terminals but voice communication links between at least two communication devices associated with different domains are not possible.

The same does not apply to data services. Normally the data connections set up between different domains are routed via data firewalls. The reason why voice transmission is not possible is that for security reasons said data firewalls block voice transmission across network or domain boundaries. The data firewalls generally block the UDP-IP data packets. Opening up data firewalls for UDP-IP data packets and therefore for voice, which is generally transmitted via such UDP-IP data packets, would signify a considerable security risk due to other UDP-IP protocols (e.g. so-called PING attacks, denial of service, etc.) and would therefore not be a satisfactory solution.

To be able to provide voice communication links between at least two subscriber communication terminals associated with different domains, the following functions have to be guaranteed at the network or domain boundaries:
only authorized subscribers are permitted to send voice data packets to a different communication network or domain,
subscribers in another domain are only permitted to use certain services in the domain in which they become host,
identical services or performance features must operate in both communication networks or domains or any non-cooperating services that have been requested must be terminated at the network boundaries,
it must be possible to log and monitor the transmission of voice data packets across the domain boundary,
the signaling of the different domains must be mutually harmonized,
the network addresses of the different domains must be made known to each other, so that the voice data packets can be sent between the respective communication terminals.

At present the transmission of voice data packets across network or domain boundaries can only be effected using conventional time division multiplex technology. As set out above, to convert the payload data for use with the transmission technology used in the different communication networks, so-called media gateways (e.g. MG in FIG. 1) must be inserted into the packet-switched communication networks. Frequent implementation of the conversion process between packet transmission technology and time division multiplex transmission technology significantly impairs voice quality. Also the media gateways mean that further hardware applications are required and these make such systems less economically attractive for network providers.

The object of the invention is to enable voice communication links between at least two subscriber communication devices associated with different domains over quite long distances across a plurality of network or domain boundaries in an economic manner and with good voice quality.

The object is achieved in respect of a network element by the features specified in claim 1 and in respect of a method by the features specified in claim 13. Advantageous embodiments of the invention are characterized in the further claims.

One important aspect of the invention is the configuration of a network element for processing signaling data and for controlling the connection of a voice communication link between at least two subscriber communication devices within a communication network associated with different packet-switched communication networks or domains. This network element has at least one signaling transmission unit for converting the data format of signaling data originating from a first domain to a data format suitable for forwarding the signaling data to a second domain and at least one media transmission unit for converting the data format of payload data originating from the first domain and associated with the voice communication link to a data format suitable for forwarding the payload data to the second domain. The signaling transmission unit hereby has additional communication means for controlling the media transmission unit using the information from the signaling data. Standardized protocols, e.g. H.248, MGCP (Media Gateway Control Protocol), COPS (Community Oriented Policing Service) and MIDCOM (Middlebox Communication) can be used to control the media transmission unit.

This network element is an IP/IP gateway based on IP, so that the voice data packets can be forwarded directly from a packet-switched communication network or domain to a different packet-switched communication network or domain without unnecessary delays due to conversions in respect of transmission technology. This IP/IP gateway means that the media gateways arranged in a TDM communication network for IP transmission are no longer necessary. The inventive network element therefore represents a cost-effective solution.

The inventive network element is in particular characterized by a master/slave relationship between the at least one signaling transmission unit and the media transmission unit. This relationship for controlling the media transmission unit includes determination of the status, capacity utilization and functionality, in particular in respect of services or performance features, of the media transmission unit. As a result the transmission of payload data via the media transmission units across network boundaries can be fully controlled.

In the case of the inventive network element, the number of signaling transmission units arranged in the network element and the number of media transmission units arranged in the network element can expediently be a function of the number of domains associated with the network element.

The signaling transmission unit arranged in the inventive network element can have the following communication means
to convert the network address format of signaling data originating from a first domain to a network address format suitable for forwarding the signaling data to a second domain,
to terminate signaling data originating from a first domain, which relates to performance features valid in the first domain, i.e. protocol termination and service conversion, monitoring and blocking,
to provide a firewall proxy functionality, as a result of which the payload data associated with the voice connection can pass a data firewall,
to control the volume of traffic and prevent overload.

The media transmission unit arranged in the inventive network element can have the following communication means:
to convert priority identifiers of signaling data originating from a first domain to priority identifiers suitable for forwarding the signaling data to a second domain,
to control the volume of traffic and prevent overload.

Depending on the volume of traffic to be managed, the logically associated transmission units can be provided in the form of the at least one signaling transmission unit (s-UE) and the at least one media transmission unit (m-UE) on a common hardware platform or on separate hardware platforms.

The inventive network element allows savings to be made on administration in respect of network addresses, which generally have to be administered in all the gatekeepers of the respective domains with regard to all inter-domain relationships. In this way only the network addresses for the adjacent domain have to be administered in the inventive network element. Also protection mechanisms against abuse from external domains or even service restrictions can be provided much more easily, as all inter-domain traffic (i.e. signaling data and payload data) is routed via a logical network element. This means that performance features relating to general security and order, e.g. judicial interception or monitoring of call connections can be provided at low cost.

A further aspect of the invention is a method for processing signaling data and for controlling the connection of a voice communication link between at least two communication devices within a packet-switched communication network associated with different domains. The method is characterized by the following steps:
conversion of the data format of signaling data coming from a first domain to a data format suitable for forwarding the signaling data to a second domain,
conversion of the data format of payload data coming from a first domain and associated with the voice communication link to a data format suitable for forwarding the payload data to a second domain and
forwarding of the converted signaling data and payload data to the second domain,
whereby the conversion of the signaling data and the conversion of the payload data are synchronized by a control system using the signaling data.

This method has the above-mentioned advantages in a similar manner.

Further embodiments and advantages of the invention will emerge from the exemplary embodiment described below, which is set out in more detail below with reference to the drawing, in which:

FIG. 1 shows an exemplary network constellation of a hybrid communication network according to the above-mentioned prior art,

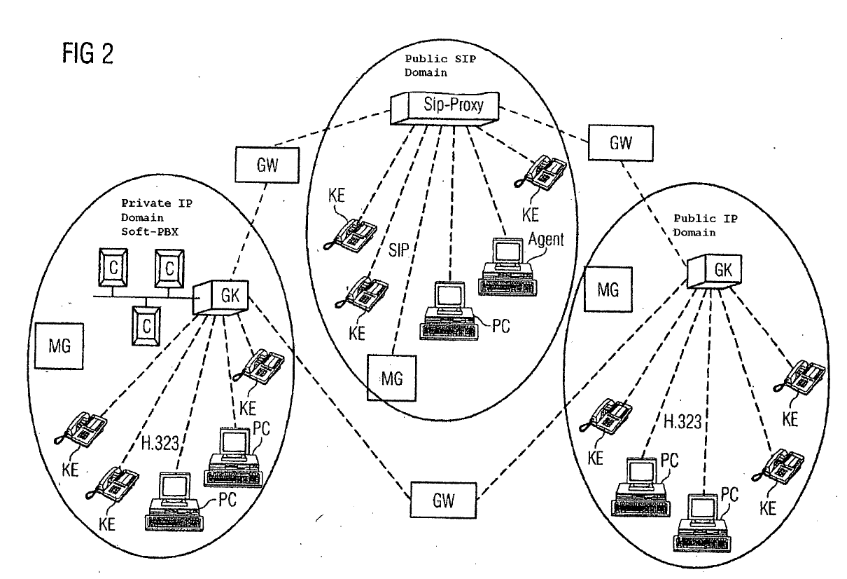

FIG. 2 shows an exemplary network constellation, in which the inventive network element is inserted at the boundaries between the packet-switched communication networks,

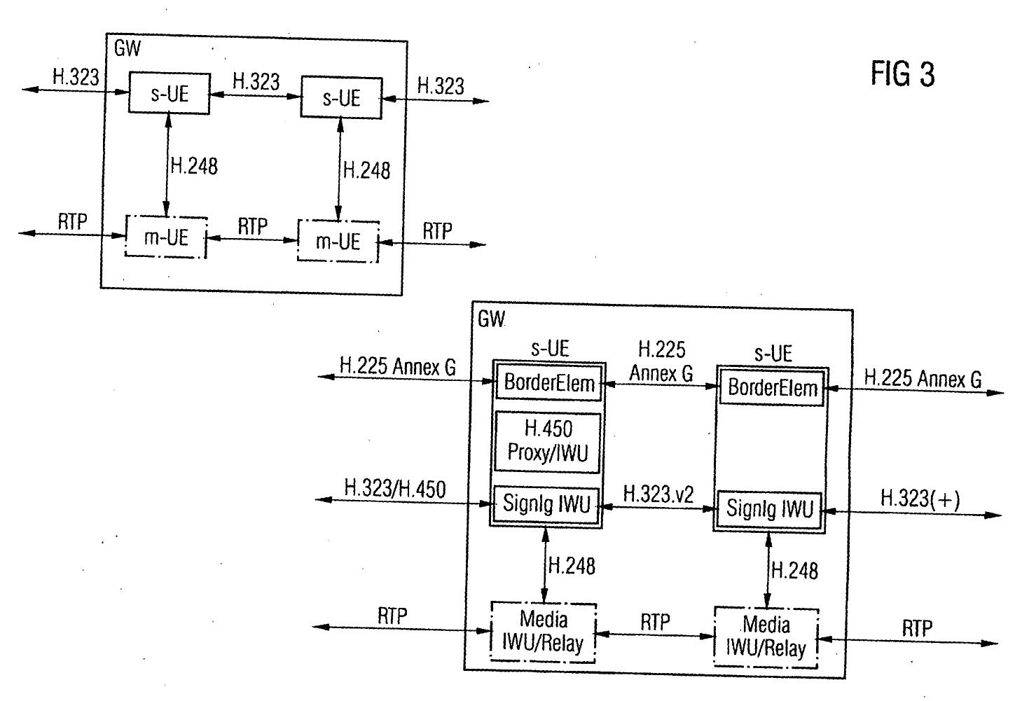

FIG. 3 shows an exemplary structure of the inventive network element,

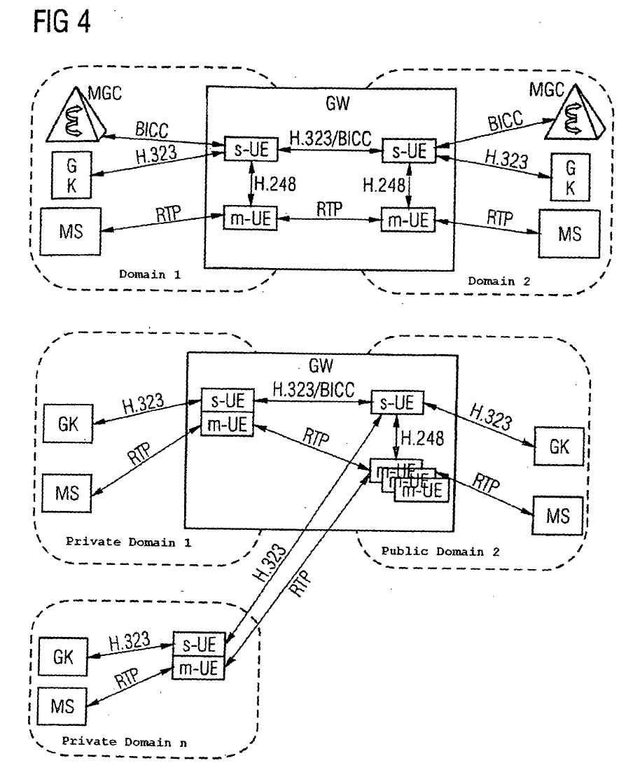

FIG. 4 shows an exemplary variant of the structure of the inventive network element,

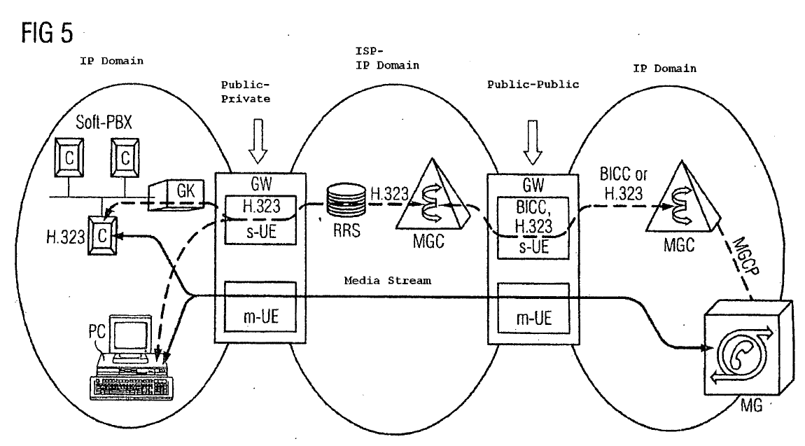

FIG. 5 shows an example of a communication link between at least two communication points in the form of communication terminals or communication transfer units associated with different domains.

FIG. 2 shows a network constellation, as in FIG. 1, except that the network element is inserted in the form of a gateway GW at the boundaries between the packet-switched communication networks “private IP domain”, “public SIP domain” and “public IP domain”.

FIG. 2 shows a typical network constellation. The transmission of voice data packets between the adjacent domains (private and public), i.e. both signaling data packets and payload data packets, passes the network element GW with its gateway functions. The network element GW is designed so that all functions are implemented either in a hardware platform or in a plurality of distributed hardware platforms. Different variants of function distribution are possible. Both a low volume of traffic and a high volume of traffic can be managed in this manner. The individual functions communicate with each other via standardized protocols.

According to FIG. 3 the network element, hereafter referred to as the gateway GW, has the following functional units:
at least one signaling transmission unit s-UE, which is essentially responsible for the following tasks:
   signaling conversion
   protocol termination
   service monitoring
   firewall proxy functionality
   address conversion for signaling and payload data information stream
   tracking of the communication links operating actively between the two domains
   control of the media transmission units m-UE
   rerouting to other media transmission units m-UE.

The functional unit of the signaling transmission unit for signaling conversion is responsible for the conversion of the signaling information of a first domain to that of a second domain and vice versa. This unit comprises one sub-unit per adjacent domain, which converts the signaling at the network or domain boundary to a reference format, which can be further processed by a corresponding unit of the respective remote station. In the case of such a signaling conversion, it may also be necessary to terminate at the network boundary (protocol termination) any information which cannot expediently be converted in the other second domain. This applies in particular to those performance features, which can in principle be converted but are not permitted for the specific calling or called subscriber (service monitoring).

The signaling transmission unit can also be represented by the following components (see FIG. 3):
a so-called border element BorderElem for setting up a point-to-point connection from one signaling transmission unit to a further signaling transmission unit (identified in FIG. 3 with the connection through H.225 Annex G).
an optional suitable proxy or interworking unit H.450 proxy/IWU for service or performance feature control, in particular performance features supported by Soft-PBX (e.g. HIPASS from Siemens AG).
a signaling unit SignIg IWU suitable for processing signaling data.

In addition to the media transmission unit, the signaling transmission unit also controls the so-called data firewall and prompts this to open both the ports provided for signaling and the ports provided for payload data transmission in a dedicated manner, in particular for transmission of the voice data packets (RTP packets), and to close them again after termination of the voice communication link (firewall proxy functionality). For this purpose in the case of IPV4 data packets the signaling transmission unit must also support the so-called NAT functionality (NAT=Network Address Translation) (address conversion for signaling data and the payload data information stream).

Current status is tracked via all active communication links between the two domains so that regulatory measures can be implemented in certain circumstances. If for example a controlled media transmission unit reports an overload, the respective controlling signaling transmission unit will if necessary reroute further incoming data traffic to other media transmission units.
at least one media transmission unit m-UE: The media transmission unit also comprises one sub-unit per adjacent domain, which converts the respective RTP format of the voice payload data packets to a reference format and communicates with the respective remote station.

The tasks of the media transmission unit include:
transmission of media payload data packets (useful information) between both domains using the control information received by the competent signaling transmission unit: under the control of the respective signaling transmission unit all voice payload data packets (RTP packets) associated with a communication link are converted to the reference format and transmitted to the respective end point (e.g. H.323 or SIP terminal MS (in FIG. 4) of the adjacent domain.

Compliance with priority data (e.g. MPLS levels (MPLS=Multi Protocol Label Switching) or TOS bits (TOS=Type of Service) or DiffServ levels (DiffServ=Differentiated Services) on the part of the controlling unit: the media gateway unit must be able to convert packets of a certain priority from its own domain to a reference format so that the corresponding unit is able to convert this reference priority format back to the priority format used respectively in its own domain.
logging the packet flow of all RTP packets transmitted across domain boundaries and the data packets associated with a communication link:
the media transmission unit associated with each specific domain counts the packets respectively received and sent for every communication link (and priority level) and establishes the total of all received and sent packets, to determine from this a result relating to capacity utilization and in some instances anticipated overload. Notification of this result is sent to the signaling transmission unit, so that appropriate counter-measures can be implemented.

The media transmission unit can be represented by a media-interworking unit/relay media IWU/relay as shown in FIG. 3 or a router or can have a fully transparent function, e.g. in the form of a null modem.

FIG. 4 shows variants of the inventive network element GW. The network element GW, represented in the upper section of FIG. 4, could typically be arranged between two public ISP networks (ISP=Internet Service Provider). In order to cope with the comparatively large volume of data traffic, the respective functional units of the signaling and media transmission units are implemented separately on high-performance hardware platforms. Communication between the functional units takes place by means of standardized protocols. In the lower section of FIG. 3 a plurality of smaller so-called enterprise domains (private domains, preferably within a company), with which the functional units of the signaling and media transmission units are primarily implemented on a hardware platform, are connected to a network element (gateway) GW of a public domain, which has a distributed structure.

FIG. 5 shows a typical network configuration for the inventive network element (gateway) GW and an exemplary communication link routed via a plurality of different communication networks. In this diagram a so-called Enterprise-Soft-PBX (PBX=private branch exchange)—e.g. a company IP network—is connected to a public IP network of an internet service provider (ISP) by means of a so-called IP/IP gateway. There is also a connection via an IP/IP gateway between the public IP network and one or a plurality of public IP networks (e.g. an IP network of a UMTS service provider (UMTS=Universal Mobile Telephone System).

1-13. (canceled)

14. A network element for processing signaling data and for controlling a connection of a voice communication link between at least two communication devices assigned to different packet-switched communication networks or different domains within a communication network, the network element comprising:
a signaling transmission unit for converting the signaling data format of signaling data originating from a first domain into a data format suitable for forwarding the signaling data to a second domain; and
a media transmission unit for converting the media data format of payload data originating from the first domain and associated with the voice communication link into a data format suitable for forwarding the payload data to the second domain, wherein
the signaling transmission unit comprises further communication mechanisms for controlling the media transmission unit using the signaling data.

15. A network element according to claim 14, wherein the signaling transmission unit controls the media transmission unit according to a master/slave relationship.

16. A network element according to claim 15, wherein the master/slave relationship comprises determination of the status, and/or capacity utilization, and/or functionality of the respective media transmission unit.

17. A network element according to claim 14, wherein the signaling transmission unit comprises a communication mechanism for converting a network address format of signaling data originating from a first domain into a network address format suitable for forwarding the signaling data to a second domain.

18. A network element according to claim 15, wherein the signaling transmission unit comprises a communication mechanism for converting a network address format of signaling data originating from a first domain into a network address format suitable for forwarding the signaling data to a second domain.

19. A network element according to claim 16, wherein the signaling transmission unit comprises a communication mechanism for converting a network address format of signaling data originating from a first domain into a network address format suitable for forwarding the signaling data to a second domain.

20. A network element according to claim 14, wherein the signaling transmission unit comprises a communication mechanism for terminating signaling data originating from a first domain and relating to performance features that are valid in the first domain.

21. A network element according to claim 15, wherein the signaling transmission unit comprises a communication mechanism for terminating signaling data originating from a first domain and relating to performance features that are valid in the first domain.

22. A network element according to claim 16, wherein the signaling transmission unit comprises a communication mechanism for terminating signaling data originating from a first domain and relating to performance features that are valid in the first domain.

23. A network element according to claim 17, wherein the signaling transmission unit comprises a communication mechanism for terminating signaling data originating from a first domain and relating to performance features that are valid in the first domain.

24. A network element according to claim 14, wherein the signaling transmission unit comprises a communication mechanism having a so-called firewall proxy functionality for enabling the payload data associated with the voice connection to pass a data firewall.

25. A network element according to claim 14, wherein the signaling transmission unit comprises a communication mechanism for controlling the volume of traffic and for preventing overload.

26. A network element according to claim 14, wherein the signaling transmission unit comprises a communication mechanism for converting and monitoring and when necessary blocking performance features.

27. A network element according to claim 14, wherein the media transmission unit comprises a communication mechanism for converting priority identifiers of signaling data originating from a first domain into priority identifiers suitable for forwarding the signaling data to a second domain.

28. A network element according to claim 14, wherein the media transmission unit comprises a communication mechanism for controlling the volume of traffic and for preventing overload.

29. A network element according to claim 14, wherein a transmission unit comprises one of the signaling transmission units and one of the media transmission units provided on a common hardware platform.

30. A network element according to claim 14, wherein a transmission unit comprises one of the signaling transmission units and one of the media transmission units provided on separate hardware platforms.

31. A method for processing signaling data and for controlling a connection of a voice communication link between at least two communication devices assigned to different packet-switched communication networks or different domains within a communication network, the method comprising:
converting a data format of signaling data originating from a first domain into a data format suitable for forwarding the signaling data to a second domain;
converting the data format of payload data originating from a first domain and associated with the voice communication link into a data format suitable for forwarding the payload data to a second domain; and
forwarding the converted signaling data and payload data to the second domain, wherein
converting the data format of the signaling data and converting the data format of the payload data are synchronized by a control system using the signaling data.
